(19) United States
(12) Patent Application Publication
(10) Pub. No.: US 2013/0166265 A1
(43) Pub. Date: Jun. 27, 2013

(54) METHOD FOR SIMULATING INDOOR ILLUMINANCE

(71) Applicants: Takaaki Suzuki, Shizuoka-city (JP); Toshifumi Kato, Shizuoka-city (JP); Miyoshi Ono, Hamamatsu-shi (JP); Susumu Toyama, Hamamatsu-shi (JP); Yasuko Koga, Fukuoka-shi (JP)

(72) Inventors: Takaaki Suzuki, Shizuoka-city (JP); Toshifumi Kato, Shizuoka-city (JP); Miyoshi Ono, Hamamatsu-shi (JP); Susumu Toyama, Hamamatsu-shi (JP); Yasuko Koga, Fukuoka-shi (JP)

(73) Assignees: SKY PLANNING CO., LTD., Hamamatsu-shi, Shizuoka (JP); SHIZUOKA PREFECTURE, Shizuoka-city, Shizuoka (JP)

(21) Appl. No.: 13/820,616

(22) PCT Filed: Sep. 5, 2011
(86) PCT No.: PCT/JP2011/004963

§ 371 Date: Mar. 4, 2013

(30) Foreign Application Priority Data
Sep. 6, 2010 (JP) 2010-198731

(51) Int. Cl. G06F 17/50

(52) U.S. Cl. CPC G06F 17/5009
USPC 703/2

(57) ABSTRACT

Described herein is a method for simulating indoor illuminance which includes preparing an intrinsic optical property function of a bidirectional transmittance function and a bidirectional reflectivity function based on values actually measured for each plate-shaped optical member; for a skylight constructed by combining a plurality of those optical members, creating an optical physical model based on the intrinsic optical property function and the construction mode of each optical member constituting the skylight; calculating the skylight light distribution data for daylight, which is introduced through the skylight, by using the optical physical model; and simulating the indoor illuminance, which would be provided by actually installing the skylight, on the basis of the light distribution data. The simulation is performed on a computer system which has stored the intrinsic optical property function of each optical member in a database.

### TECHNICAL FIELD

The present invention relates to a method for simulating the indoor illuminance of daylight admitted through a skylight.

### BACKGROUND ART

The recent implementation of the Revised Energy Saving Act and other regulations has called for energy management in businesses and enterprises, and CO₂ reduction and a shift to alternative energy have become an urgent issue.

Skylights are commonly used for houses to admit outside light into a room that has no windows or to provide lighting in a room without using artificial light.

However, use of skylights is not so common in indoor facilities with workspaces such as factories. JIS specifies lighting standards for illumination distributions such as illuminance and uniformity ratio in indoor workplaces. Accordingly, in the conventional daylighting design including skylights, it has been common practice to admit light through a skylight with a device that blocks direct sunlight to suppress the excessive contrast to the direct sunlight.

However, because the light quantity of direct sunlight is much greater than the quantity of the lighting through the skylight, the method of admitting direct sunlight requires ingenuity to make effective use of light quantity from resource and energy saving considerations.

### CITATION LIST

### Patent Documents

Japanese Patent Laid-Open (KOKAI) Document 1: JP-A-11-258035

### SUMMARY OF THE INVENTION

### Problems that the Invention is to Solve

It has been proposed to suppress the excessive contrast to direct sunlight and satisfy the JIS lighting standards with the use of a diffusion plate attached to a skylight.

However, designing a skylight in advance is difficult, because light distribution characteristics such as the luminance and the distribution of the daylight obtained through a skylight greatly differ depending on the optical characteristics or the installation place of the diffusion plate, and the position of the sun during each season and various times of day.

Patent Document 1 proposes a building daylight calculation method in which light distribution characteristics are actually measured for each skylight. However, the numerous types of optical members currently proposed for skylights are too much of a burden for this method, even though the method can be used for the predesigning of skylights. Further, the device used for the measurement disclosed in the Patent Document 1 is a specified one, and is not commercially available. For these reasons, it is indeed difficult to use the proposed method of the Patent Document 1 in actual practice.

The present invention has been made in view of these problems, and it is an object of the present invention to provide a novel and useful indoor illuminance simulation method that makes it easier to design a skylight in advance.

Another object of the present invention is to provide skylight light distribution data used to easily perform the indoor illuminance simulation method, a skylight light distribution database storing more than one such data, and an indoor illuminance simulation system that uses the database.

### Means for Solving the Problems

The present invention has been completed for achieving the foregoing objects.

There is provided a first aspect which provides a method for simulating indoor illuminance, the method comprising performing a calculation with an optical physical model to obtain skylight light distribution data for the daylight admitted through a skylight, and using the light distribution data to calculate an indoor illuminance for the skylight to be installed.

There is provided a second aspect of the indoor illuminance simulation method according to the first aspect, in which the optical physical model is created for a skylight configured from a combination of a plurality of plate-shaped optical members according to intrinsic optical property functions of each optical member forming the skylight and a construction mode of the optical members, the intrinsic optical property functions being set for each plate-shaped optical member according to measured values.

There is provided a third aspect of the indoor illuminance simulation method according to the second aspect, in which the intrinsic optical property functions set for each plate-shaped optical member according to measured values are a bidirectional transmittance function and a bidirectional reflectance function.

There is provided a fourth aspect of the indoor illuminance simulation method according to the third aspect, in which the measured values are spectral transmittance and spectral reflectance, and the simulation involves a calculation of indoor illuminance, and an evaluation of color rendering properties for the daylight admitted through the skylight.

There is provided a fifth aspect of the indoor illuminance simulation method according to any one of the first to fourth aspects, in which the light distribution data are calculated by solving a three-dimensional optical simulation model created with a skylight disposed beneath a virtual sky on a pseudo-hemisphere reproducing daylight with a plurality of point sources.

There is provided a sixth aspect which provides skylight light distribution data created by performing the indoor illuminance simulation method of any one of the first to fifth aspects, and associated with the type of skylight with respect to a skylight module created by dividing a skylight expected to be installed.

There is provided a seventh aspect of the skylight light distribution data according to the sixth aspect, in which the data are also associated with the types of solar altitude, solar azimuth, and sky condition.

There is provided an eighth aspect which provides a skylight light distribution database storing the skylight light distribution data according to the sixth or seventh aspect.

There is provided a ninth aspect which provides a skylight associated with the skylight light distribution data calculated according to the indoor illuminance simulation method according to any one of the first to fifth aspects.

There is provided a tenth aspect which provides an indoor illuminance simulation system that uses the skylight light distribution database according to the eighth aspect, and that calculates an indoor illuminance upon extracting skylight light distribution data stored in the skylight light distribution database and associated with the type of skylight, the number of skylight modules, and an installation place used as design parameters.

### Advantage of the Invention

The indoor illuminance simulation method of the present invention makes it easier to design a skylight in advance.

### BRIEF DESCRIPTION OF THE DRAWINGS

FIG. 1 represents an example of a skylight construction mode.

FIG. 2 is an explanatory diagram representing the measurement method of the optical characteristics of an optical member.

FIG. 3 is a diagram representing examples of measurement results.

FIG. 4 is a diagram representing an example of an optical simulation model.

FIG. 5 is a diagram representing examples of the results of calculated light distributions.

FIG. 6 is a diagram representing an indoor illuminance distribution for installed skylights.

FIG. 7 is a diagram representing an example of the actual predesign specifications presented to a client.

FIG. 8 is a diagram representing an exemplary indoor illuminance simulation system.

FIG. 9 is a diagram representing another exemplary indoor illuminance simulation system.

### MODE FOR CARRYING OUT THE INVENTION

An indoor illuminance simulation method according to an embodiment of the present invention is described below with reference to the accompanying drawings.

### <Creation of Optical Simulation Model>

### A. (Creation of Virtual Sky)

A direct sunlight point source is set on a hemispherical virtual sky along with a large number of skylight point sources or parallel ray light sources corresponding thereto.

The luminance of the direct sunlight is calculated from the direct sunlight normal illuminance En on the earth's surface. The direct sunlight normal illuminance En is finally calculated from the following equation after finding the solar altitude and the solar azimuth, using the installation place (latitude, longitude) and the date and time as input parameters.

[Equation 1]

Direct sunlight normal illuminance Eₙ=E₀·e^{-am}
m: Optical air mass (≈1/sin(γₛ))
γₛ: Solar altitude
E₀: Extraterrestrial normal illuminance
a: Extinction coefficient
Solar altitude

γₛ=arcsin{sin (φ) sin (δ)+cos (φ) cos (δ) cos (t)}

φ: Longitude of target point

δ: The Sun's declination (can be calculated by approximation from days dn from the New Year's day)

t: Hour angle=15×(JST-12)+difference of longitude from the prime meridian+equation of time Et

Et: (can be calculated by approximation from days dn from the New Year's day)

Various model formulae are proposed for skylight luminance distributions, including, for example, CIE standard clear sky, CIE standard overcast sky, intermediate sky (Nakamura et al.), CIE standard general sky, and all sky model, and these are appropriately selected according to the weather.

The following is an example of such model formulae.

$$\begin{matrix}( CIE standard clear sky ) \\ L = {L}_{z} \frac{f ( ζ ) * φ ( γ )}{f ( \frac{π}{2} - {γ}_{s} ) * φ ( \frac{π}{2} )} \\ L \text{:} Luminance of sky element & [ Equation 2 ] \\ ξ = {cos}^{- 1} ( sin {γ}_{s} * sin γ + cos {γ}_{s} * cos γ * cos \vert {α}_{s} - α \vert ) \\ f ( ξ ) = 0.91 + 10 {e}^{- 3 ξ} + 0.45 {cos}^{2} ξ & \\ f ( \frac{π}{2} - {γ}_{s} ) = 0.91 + 10 {e}^{- 3 ( \frac{π}{2} - {γ}_{s} )} + 0.45 {cos}^{2} ( \frac{π}{2} - {γ}_{s} ) \\ Zenith luminance \text{:} {L}_{z} = 6.4 {\{ tan ( 0.846 {γ}_{s} ) \}}^{1.18} + 014 & \end{matrix}$$

A virtual hemispherical sky is imagined over a skylight according to the shape of the skylight installed, and the axial azimuth of the optical inplane anisotropy of a diffusion plate. The virtual sky is divided into fine elements of equal solid angles, and the direct sunlight luminance and the sky luminance distribution calculated from the foregoing equations are applied to each element to complete the virtual sky.

### B. (Creation of Skylight Optical Physical Model)

### (1) Measurement of Optical Characteristics of Plate-Shaped Optical Members

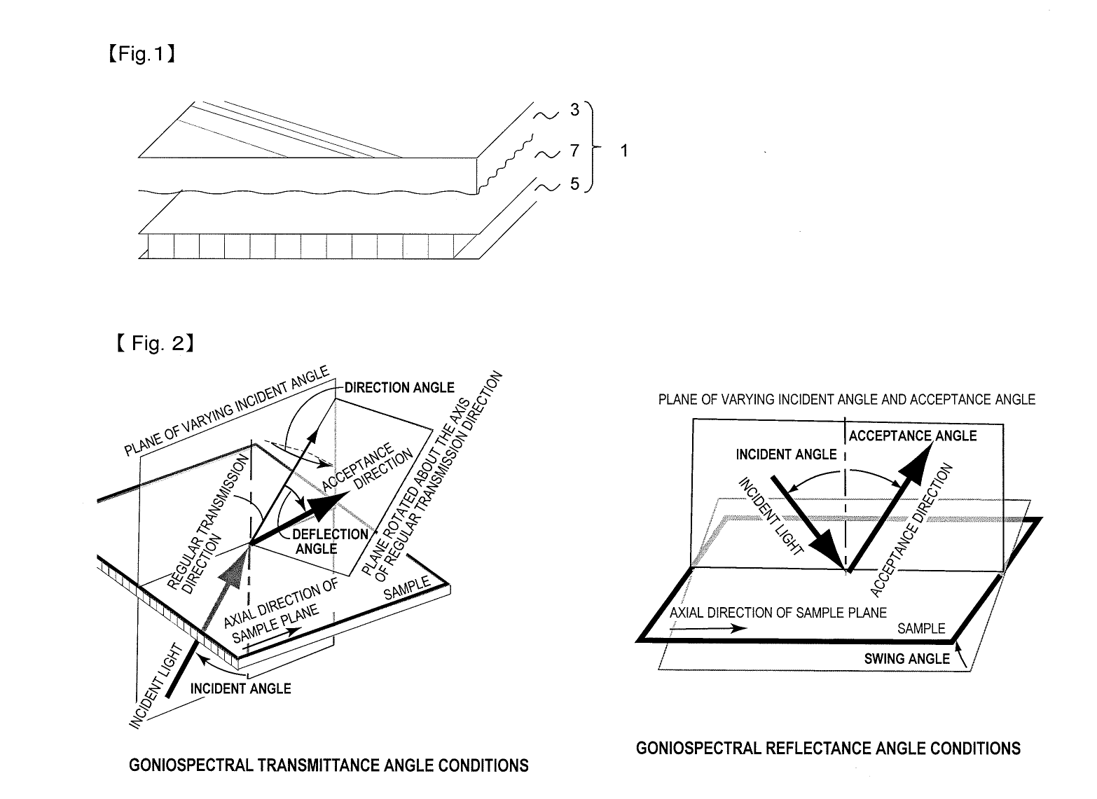

Plate-shaped optical members refer to components of a skylight. FIG. 1 illustrates an exemplary skylight 1. The skylight 1 is configured from a glass plate 3, a diffusion plate 5 having a hollow layer, and an air layer 7 disposed between these plates. In the skylight 1, the glass plate 3 and the diffusion plate 5 having a hollow layer independently constitute plate-shaped optical members.

All the plate-shaped optical members, including those described above, having potential use are measured for goniospectral transmittance and goniospectral reflectance (solid angle spectral transmittance and reflectance specified in JIS8722), as represented in FIG. 2. The light is measured by spectral photometry to enable an evaluation of color rendering properties for the light admitted through a skylight that uses an optical member such as a colored heat reflection glass. As an example, the measurement is made in the visible range at spectral wavelengths of 390 to 730 nm in 10-nm intervals.

The measurement angle conditions are set as presented in Table 1. Because the diffusion plate 5 having a hollow layer has the possibility of showing inplane anisotropy, the axial direction of a sample plane is measured in more than one direction with respect to the plane of varying incident angles.

Note that the intervals set for the measurement angle conditions are not regular, and are smaller in the vicinity of the regular direction where the light has greater quantities and undergoes large changes.

TABLE 1
Measurement angle conditions

| | |
|---|---|
| Transmittance | Incident angle: 0 to 90 degrees |
| (Diffuse transmission) | Direction angle: 0 to 180 degrees |
| | Deflection angle: 0 to 180 degrees |
| | Inplane rotation angle: 0 to 360 degrees |
| Transmittance | Incident angle: 0 to 70 degrees |
| (Regular transmission) | |
| Reflectance | Incident angle: −30 to 60 degrees |
| (Diffuse reflectance) | Acceptance angle: −25 to 85 degrees |
| | Swing angle: 0 to 55.7 degrees |
| Reflectance | Incident angle: 10 to 70 degrees |
| (Regular reflectance) | |

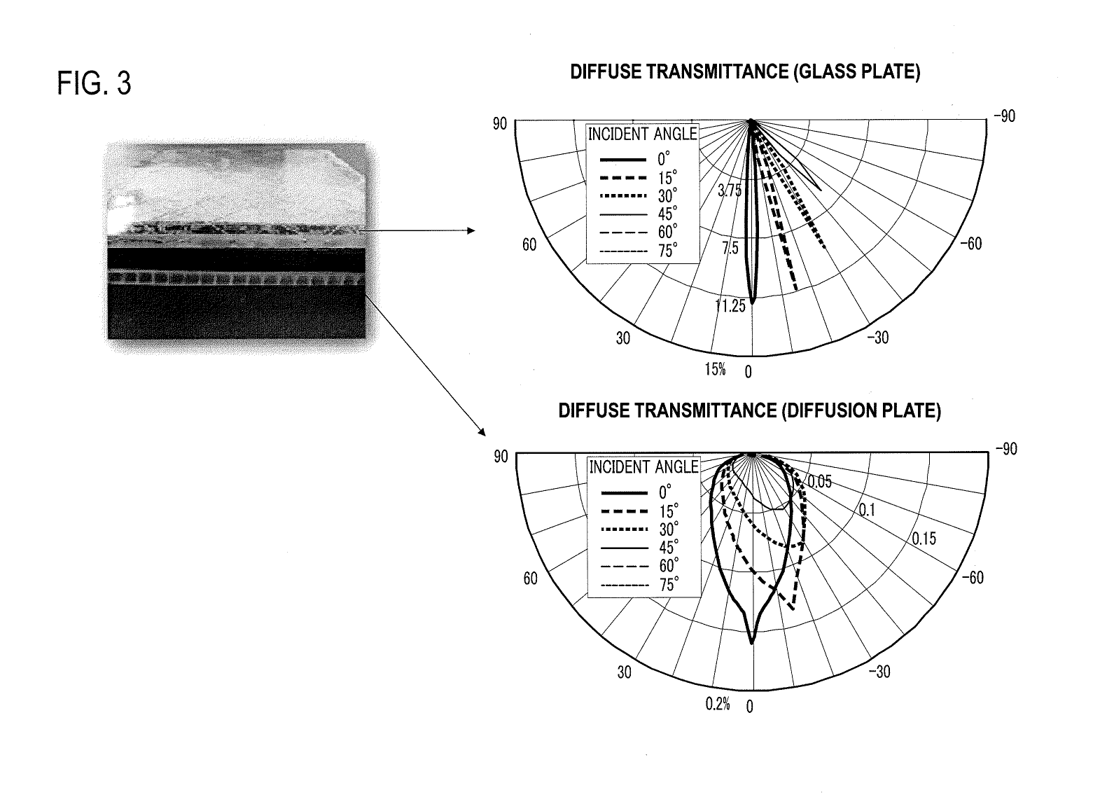

FIG. 3 represents examples of the results of the measurements performed in the manner described above, showing the extent of the spread and the transmittance of the transmitted light (visible light) on a predetermined plane with respect to a plurality of incident angles with the direction angle being equal to the incident angle.

Overall, the spread of the transmitted light is narrow in the glass plate 3, whereas it is wider in the diffusion plate having a hollow layer (here, white semi-transparent).

### (2) Creation of Bidirectional Transmittance and Reflectance Distribution Functions

A bidirectional transmittance function and a bidirectional reflectance function are created as probability distribution functions for each optical member from the optical characteristics measurement data obtained in the manner described as above, using an ordinary method.

### (3) Creation of Skylight Optical Physical Model

A skylight optical physical model (goniospectral transmittance and reflectance and the geometrical position of the optical member) are created from the two intrinsic functions of each optical member, and the construction modes of the optical members, for example, the vertical relationship between the two optical members, the glass plate 3 and the diffusion plate 5 having a hollow layer, of the skylight 1 shown in FIG. 1, and the distance between the center planes of the optical members along the thickness direction.

### C. (Creation of Optical Simulation Model)

A three-dimensional optical simulation model is created from A and B above.

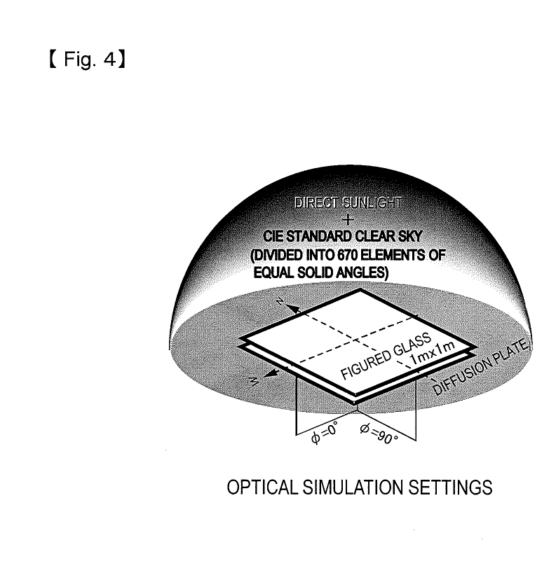

In this optical simulation model, the skylight 1 is disposed beneath the hemispherical virtual sky, as illustrated in FIG. 4.

### D. (Construction of Light Distribution Data)

Light distribution data are obtained by solving the optical simulation model, using a method such as a ray tracing method.

For example, the luminance and the direction of the daylight passing through the skylight are calculated as light distribution data according to a bidirectional Monte Carlo ray tracing method, using the three-dimensional optical simulation software SPECTER (Integra).

The horizontal angles Φ of light distribution are 0 degree and 90 degrees directly west and south, respectively, of the normal line axis of the plane center. The light distribution is over the range of Φ=0 to 360 degrees at 5-degree intervals, and the range of vertical angle θ=0 to 90 degrees at 5-degree intervals.

FIG. 5 represents examples of the calculated light distributions on the date of autumnal equinox (9 a.m., noon, 3 p.m., 36° N 140° E. FIG. 5(b) corresponds to the skylight 1 (the glass plate 3+the diffusion plate 5 having a hollow layer (white semi-transparent)). FIG. 5(a) and FIG. 5(c) correspond to skylights that use a surface-textured clear plate and a white plate, respectively, as the diffusion plate 5 having a hollow layer.

The extent of diffusion is small and the light distribution is very sharp in the surface-textured clear plate (FIG. 5(a)), and the extent of diffusion is similar in the white semi-transparent plate (FIG. 5(b)) and the white plate (FIG. 5(c)). However, the luminance value of the white plate (FIG. 5(c)) is about ¼ of the luminance value of the white semi-transparent plate (FIG. 5(b)). As demonstrated above, the different skylights produce different light distribution data.

### E. (Indoor Illuminance Simulation)

The format of the light distribution data calculated in D above is converted into the IES light distribution data format (IESNA: CM-63-1995), and the indoor daylight illuminance is calculated using all-purpose illumination environment setting software DIALux (DIAL GmbH).

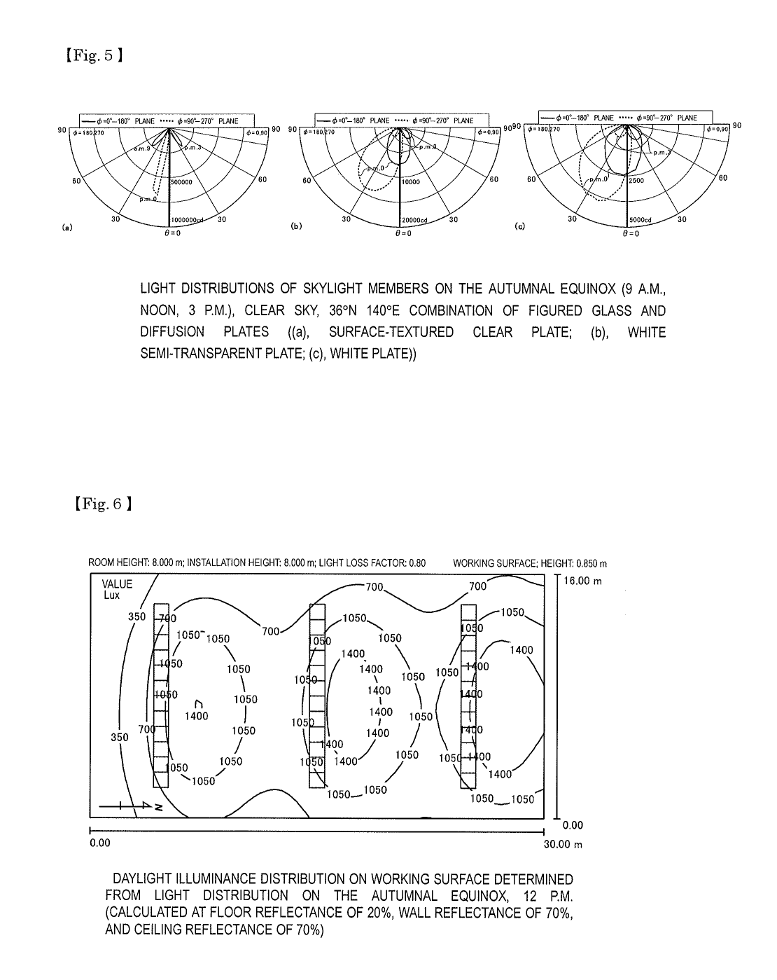

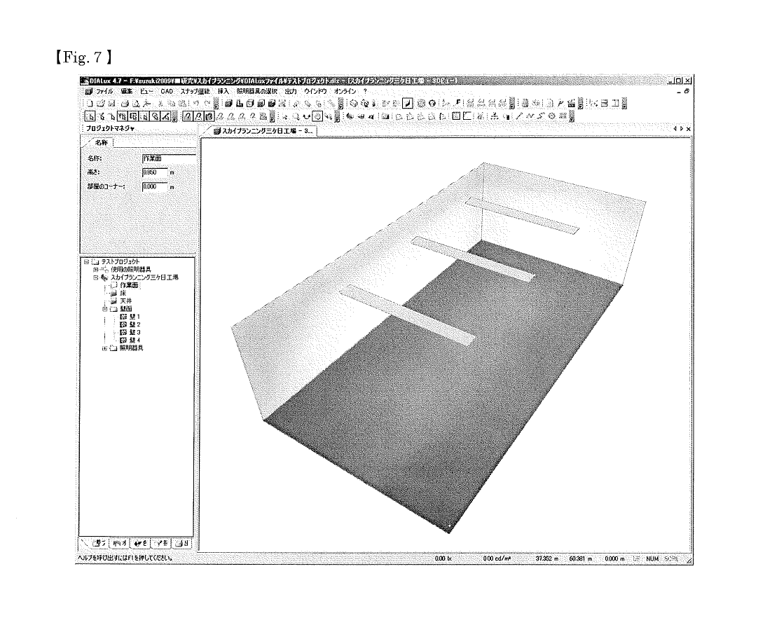

FIG. 6 represents the indoor illuminance distribution for the skylight (FIG. 5(b); white semi-transparent) installed in the room shown in FIG. 7 (installation height: 8.000 m; working surface height: 0.850m; 12p.m. on the date of autumnal equinox).

The indoor illuminance distribution for the installation of the skylight as shown in FIG. 7 can thus be presented to the client after completing the predesign shown in FIG. 6.

The method can be performed by using a simulation system configured from a computer that includes input units such as a keyboard and a mouse, output units such as a display and a printer, and a storage medium storing computer programs and data, and by executing the computer programs with the system.

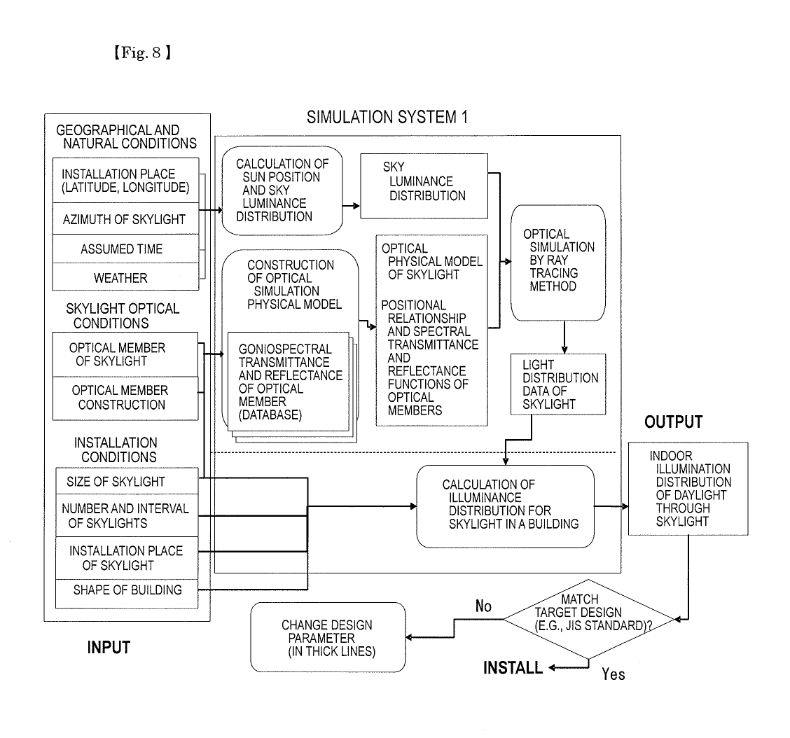

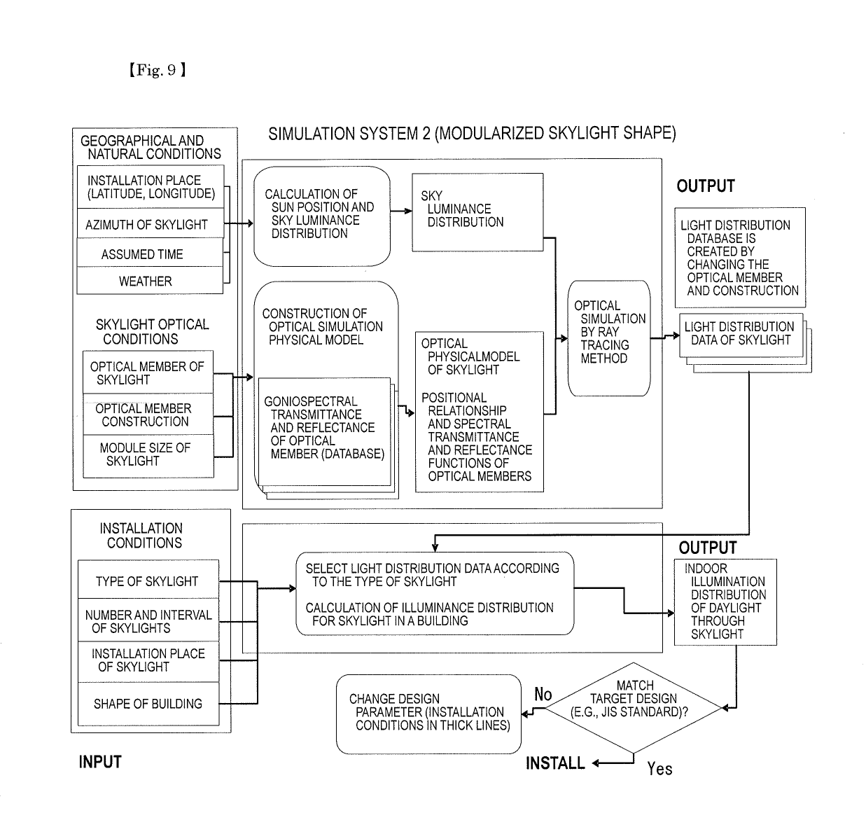

FIG. 8 and FIG. 9 show exemplary system structures.

The input parameter “Geographical and natural conditions” is used to create a virtual sky, and the “Skylight optical conditions” is used to create the optical physical model of the optical member. These are used to calculate the light distribution data.

The “Installation conditions” is used to calculate the indoor illuminance distribution with the light distribution data. The sub-parameter “Building shape” is used to define the shape of the building to be installed with a skylight, and the distance from the ceiling provided with the skylight down to the plane, for example, a working surface, of an unknown illuminance.

The simulation of indoor illuminance is finished upon the calculated indoor illuminance distribution satisfying the target value. If the target value is not satisfied, changes are made to the design parameters in the input parameters.

The design parameters typically include the optical member of the skylight (the type of the optical member forming the skylight), the construction of the optical member (the construction mode of the optical member), the size of the skylight, the number of skylights, the intervals between the skylights, and the installation place of the skylight.

In FIG. 8, the optical simulation model is created taking into consideration the size of the skylight, and a database is created only for the optical simulation model. The light distribution data is created every time the design parameter, specifically the size of the skylight is changed.

On the other hand, in FIG. 9, the size of the skylight expected to be installed is modularized by dividing the skylight size by a certain number, and a database is created in advance for the light distribution data calculated for the module area. The illuminance distribution can then be calculated on the assumption that a plurality of such modularized skylights are placed. This reduces the calculation burden.

While the embodiment of the present invention has been discussed in the foregoing detailed explanation, the specific configurations are not limited to the ones described above, and may be applied in many design variations within the spirit of the present invention, provided such variations do not exceed the gist of the present invention.

### INDUSTRIAL APPLICABILITY

The present invention is applicable to the development, design, and installation of skylights.

### DESCRIPTION OF REFERENCE NUMERALS AND SIGNS

1 Skylight
3 Glass plate
5 Diffusion plate having a hollow layer
7 Air layer

1. A method for simulating indoor illuminance,
the method comprising performing a calculation with an optical physical model to obtain skylight light distribution data for the daylight admitted through a skylight, and using the light distribution data to calculate an indoor illuminance for the skylight to be installed.

2. The method according to claim 1, wherein the optical physical model is created for a skylight configured from a combination of a plurality of plate-shaped optical members according to intrinsic optical property functions of each optical member forming the skylight and a construction mode of the optical members, the intrinsic optical property functions being set for each plate-shaped optical member according to measured values.

3. The method according to claim 2, wherein the intrinsic optical property functions set for each plate-shaped optical member according to measured values are a bidirectional transmittance function and a bidirectional reflectance function.

4. The method according to claim 3, wherein the measured values are spectral transmittance and spectral reflectance, and wherein the simulation involves a calculation of indoor illuminance, and an evaluation of color rendering properties for the daylight admitted through the skylight.

5. The method according to claim 1, wherein the light distribution data are calculated by solving a three-dimensional optical simulation model created with a skylight disposed beneath a virtual sky on a pseudo-hemisphere reproducing daylight with a plurality of point sources.

6. A skylight light distribution data created by performing the method of claim 1, and associated with the type of skylight with respect to a skylight module created by dividing a skylight expected to be installed.

7. The skylight light distribution data according to claim 6, wherein the data are also associated with the types of solar altitude, solar azimuth, and sky condition.

8. A skylight light distribution database storing the skylight light distribution data of claim 6.

9. A skylight associated with the skylight light distribution data calculated according to the indoor illuminance simulation method of claim 1.

10. An indoor illuminance simulation system that uses the skylight light distribution database of claim 8, and that calculates an indoor illuminance upon extracting skylight light distribution data stored in the skylight light distribution database and associated with the type of skylight, the number of skylight modules, and an installation place used as design parameters.
